(19) United States
(12) Patent Application Publication
(10) Pub. No.: US 2014/0055391 A1
(43) Pub. Date: Feb. 27, 2014

(54) METHOD FOR INCREASING A SCANNING RATE ON A CAPACITANCE SENSITIVE TOUCH SENSOR HAVING AN XY ELECTRODE GRID

(71) Applicant: CIRQUE CORPORATION, Salt Lake City, UT (US)

(72) Inventor: Brian Monson, Farmington, UT (US)

(73) Assignee: CIRQUE CORPORATION, Salt Lake City, UT (US)

(21) Appl. No.: 13/972,705

(22) Filed: Aug. 21, 2013

Related U.S. Application Data
(60) Provisional application No. 61/691,480, filed on Aug. 21, 2012.

(51) Int. Cl. G06F 3/01

(52) U.S. Cl. CPC G06F 3/01
USPC 345/173

(57) ABSTRACT

A system and method for increasing a scanning rate, reducing the effects of noise and reducing power consumption when using a touch sensor having an electrode grid formed by co-planar but orthogonal XY electrodes, wherein the touch sensor may be used to determine the position of an object on a surface of the touch sensor in two measurement cycles, one set of electrodes functioning as a single large drive electrode and the other set of electrodes functioning as a single large sense electrode for a first measurement cycle, then the functions being switched for a second measurement cycle.

### BACKGROUND OF THE INVENTION

1. Field of the Invention

This invention relates generally to touch sensors. More specifically, the present invention is a system and method for increasing a scanning rate using a traditional XY grid which can capture the full XY image in two measurements when a single finger is present.

2. Description of Related Art

There are several designs for capacitance sensitive touch sensors. It is useful to examine the underlying technology to better understand how any capacitance sensitive touch sensor can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24. Although the CIRQUE® touchpad described above uses a grid of X and Y electrodes 12, 14 and a separate and single sense electrode 16, the sense electrode can actually be the X or Y electrodes 12, 14 by using multiplexing. It should also be understood that the CIRQUE® touchpad technology described above can be modified in order to function as touch screen technology.

### BRIEF SUMMARY OF THE INVENTION

In a first embodiment, the present invention is a system and method for increasing a scanning rate, reducing the effects of noise and reducing power consumption when using a touch sensor having an electrode grid formed by co-planar but orthogonal XY electrodes, wherein the touch sensor may be used to determine the position of an object on a surface of the touch sensor in two measurement cycles, one set of electrodes functioning as a single large drive electrode and the other set of electrodes functioning as a single large sense electrode for a first measurement cycle, then the functions being switched for a second measurement cycle.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which may be modified to operate in accordance with the principles of the present invention.

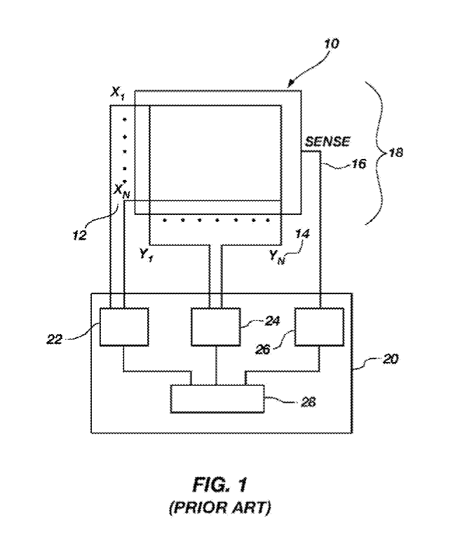

FIG. 2 is a top view of an example of the first embodiment, where the plurality of X electrodes all function as drive electrodes while the plurality of Y electrodes all function as sense electrodes, and then the roles are reversed.

FIG. 3 is an alternative embodiment where the drive and sense circuitry functions are combined in a single drive and sense controller.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “capacitive touch sensor device”, “touchpad”, “touch panel” and “touch screen”.

In a first embodiment of the present invention, touch sensor technology having an XY grid of electrodes may be adapted for use with the present invention. In the prior art, a drive signal is transmitted on groups of X electrodes, and sensed on either a single sense electrode or on groups of Y electrodes that function as sense electrodes. Various groups of electrodes are stimulated with a drive signal while sensing is performed on associated sense electrodes in a single axis. Then measurements are performed in this manner along another axis. Many measurements may be required to determine the location of a finger or fingers on the touch sensor.

The first embodiment is different from the prior art because only two measurements are required. In this first embodiment, all of the electrodes of a single axis are simultaneously driven with the same drive signal. For example, the X electrodes may be arbitrarily selected to function as the drive electrodes for a first measurement. When the drive signal is transmitted by all of the X electrodes, all of the Y electrodes may be functioning as sense electrodes. The result is an “image” of everything that is on the touch sensor from the perspective of the Y electrodes, as understood by those skilled in the art.

After the first measurement, the functions of the electrodes may then be reversed. Therefore, all of the Y electrodes may now be functioning as a single drive electrode, and the drive signal is simultaneously transmitted on all of the Y electrodes. When the drive signal is transmitted, all of the X electrodes may now be functioning as sense electrodes. Again, the result is an “image” of everything that is on the touch sensor from the perspective of the X electrodes, as understood by those skilled in the art.

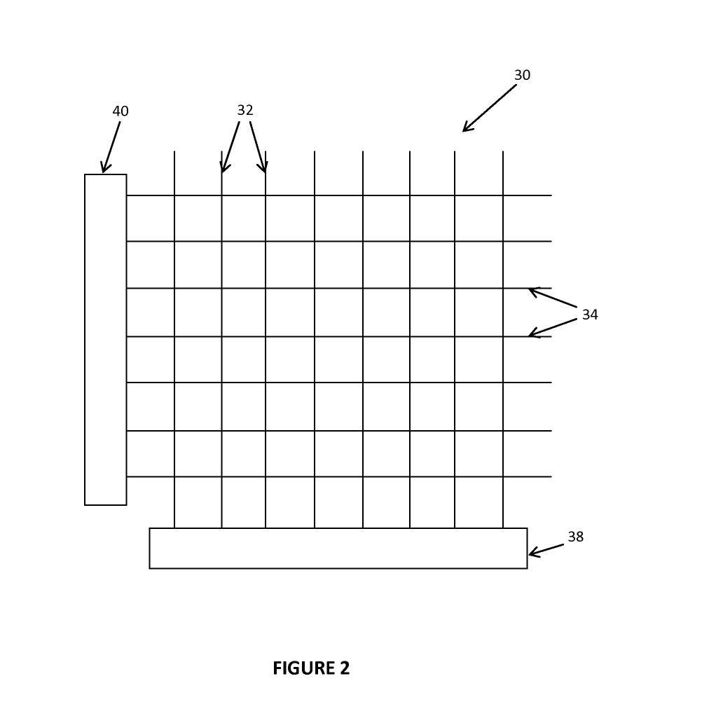

FIG. 2 is provided as an example of the first embodiment. FIG. 2 is a top view of an XY electrode grid 30 that may be used in a touch sensor of the first embodiment. The touch sensor 30 includes a plurality of X electrodes 32 and a plurality of Y electrodes 34. The specific number of X and Y electrodes being used in each set of electrodes may be increased and decreased as desired, and should not be considered a limiting factor. No limitation on the number of electrodes is being implied by FIG. 2.

The plurality of X electrodes 32 may transmit a drive signal from drive and sense circuitry 38 of the touch sensor 30. At the same time, the plurality of Y electrodes 34 may receive sense signals that are simultaneously received by drive and sense circuitry 40 of the touch sensor 30. The transmission of the drive signal and simultaneously receiving the sense signals may comprise the first measurement cycle.

For the second measurement cycle, the plurality of Y electrodes 34 may transmit a drive signal from drive and sense circuitry 40 of the touch sensor 30. At the same time, the plurality of X electrodes 32 may receive sense signals that are simultaneously received by drive and sense circuitry 38 of the touch sensor 30. Thus, the drive and sense circuitry 38 may also function as sense circuitry, or the sense signals may be directed to appropriate drive or sense circuitry as needed.

The position of the finger may be calculated using standard prior art position determining techniques that require more than the two measurements of the present invention. No new position determining routines are necessary.

This type of capacitance sensitive system is inherently ghosted (detects a false “ghost” image of a detectable object) when more than one finger is present on the touch sensor 30. Ghosting refers to the inability of a touch sensor to determine the actual location of a finger because it may appear to be in two different locations at the same time due to the nature of the capacitive sensing technology being used. In other words, the first embodiment may provide single axis image information.

Thus, N number of fingers may be detected in the X axis and N number of fingers may be detected in the Y axis. The X and Y positions may not be inherently correlated so anything more than one finger position will cause ghosted finger positions. The actual finger positions may then be determined by a process known as de-ghosting, by performing individual electrode traditional drive/sense measurements. In other words, the first embodiment operates very efficiently and quickly when there is a single finger present. However, for each finger that is added to the surface of the touch sensor 30, more and more measurements must be performed in order to de-ghost the image and determine the actual positions of the multiple fingers.

As the finger count increases, the improvements achieved by the first embodiment in time and power consumption may decrease. However, for single finger detection, this method and system of scanning may be the fastest that is theoretically possible, and consume the least amount of power. The first embodiment may also reduce noise or be less susceptible to noise than the prior art.

As stated above, the scan rate may be substantially faster using the first embodiment as compared to prior art methods. In other conventional scan methods, individual electrodes need to be driven sequentially or in a spread/balanced approach. Using conventional methods, the numbers of measurements may match the electrode count. Thus, for a 16×16 array, at least 16 drive measurements per axis may be required for finger detection and position determination. In contrast, in the first embodiment, only two measurements capture an image of the entire X and Y axes, thus resulting in the large increase in speed.

It was also stated that noise may be reduced in the first embodiment. Specifically, the signal on the touch sensor 30 is all received simultaneously. The advantage of receiving the sense signals on all of the sense electrodes at the same time is that any noise on the touch sensor 30 will affect all of the measurements of the sense signals by a same degree. Typically, the noise may be manifested as an offset in a signal on a sense line. Because the prior art may make measurements over a period of time, the noise signal may change, making the position determination less accurate. However, by making all of the measurements at the same time from all of the sense electrodes, the potential for noise to make the position determination less accurate may be reduced or eliminated. In other words, even if noise is present, it may be affecting all of the measurements simultaneously. Therefore it is likely that any noise being detected may be affecting all of the electrodes in substantially the same manner, but changing over time. By eliminating the variable of time, the present invention reduces vulnerability to noise. This means that position jitter should be significantly improved by this first embodiment because noise is affecting all of electrodes simultaneously.

Another advantage of the first embodiment is that a faster scan rate (fewer measurements) results in lower power usage. Because only one measurement is required to capture the entire touch sensor in either the X or Y dimensions, and only two measurements for both axes, active mode current may be reduced by 1/16th the power of a full axis receive system and 1/64th the power of a 4 ADC sensing system. This type of scan may be the lowest power consumption possible because it is accomplished with one single measurement for each axis.

Regarding the phenomenon of ghosting and the technique of de-ghosting, this process is well known to those skilled in the art and is taught in U.S. patent application Ser. No. 13/397,527, filed Feb. 15, 2012.

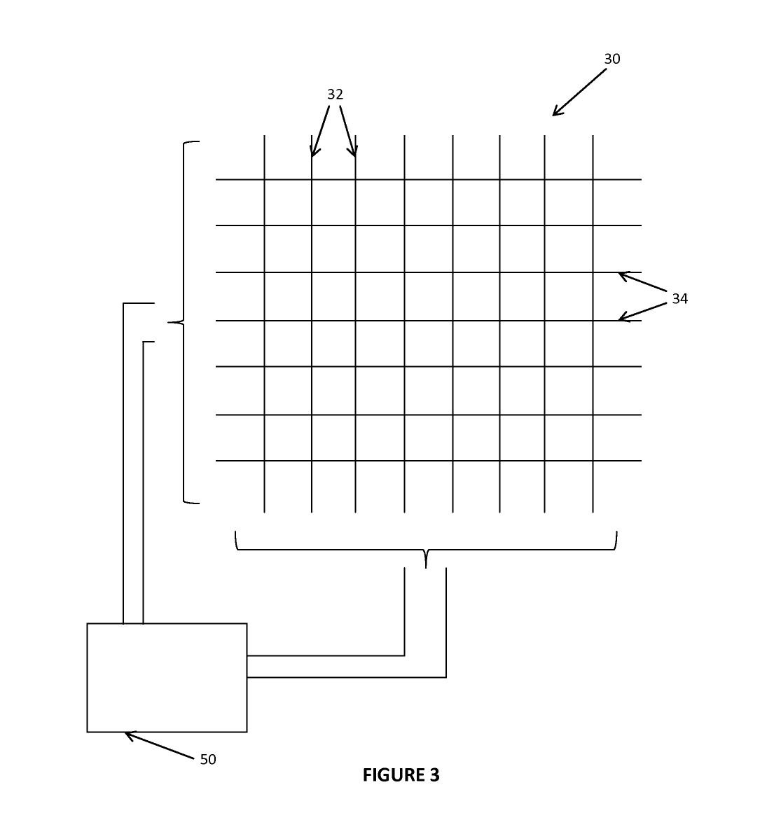

FIG. 3 is provided as an alternative embodiment of the present invention. In this figure, the drive and sense circuitry is combined into a single drive and sense controller 50 that is able to transmit drive signals and receive sense signals.

Another aspect of the invention is related to the concept of proximity sensing. It has been explained above that all of the electrodes of a single axis are simultaneously driven with the same drive signal. In the example that was given, a first set of electrodes is driven, and then the functions are switched so that the other set of electrodes are also driven.

The interesting and beneficial result is that when large numbers of electrodes are driven (toggled), the effect is to increase the projection of an electric field from the surface of the touch sensor 30. An electric field that is projected farther from the surface of the touch sensor 30 results in the ability to detect a detectable object at a greater distance from the touch sensor than is possible when using prior art methods for toggling the electrodes. Thus, by simultaneously toggling a large number of X and Y electrodes, the touch sensor 30 is capable of improved proximity sensing because of the projected electric field.

Accordingly, another aspect of the invention is that by performing the large simultaneous toggling of electrodes in the first and second measurement cycles, the touch sensor 30 enjoys improved electric field projection and therefore improved proximity sensing.

It is to be understood that the above-described arrangements are only illustrative of the application of the principles of the embodiments of the invention. Numerous modifications and alternative arrangements may be devised by those skilled in the art without departing from the spirit and scope of the present invention. The appended claims are intended to cover such modifications and arrangements.

What is claimed is:

1. A system for reducing the effect of noise on a touch sensor, said system comprising:
a plurality of parallel X electrodes disposed in a first plane, and a plurality of parallel Y electrodes disposed in a second plane, wherein the Y electrodes are co-planar with but orthogonal to the X electrodes;
drive circuitry for simultaneously transmitting a drive signal on the plurality of X electrodes that are selected to function as the drive electrodes; and
sense circuitry for simultaneously receiving a signal from the plurality of Y electrodes that are functioning as the sense electrodes, wherein any noise affecting the touch sensor is simultaneously received on the sense electrodes during a single measurement cycle.

2. The system as defined in claim 1 wherein the system is further comprised of a controller for switching the functions of the plurality of X and Y electrodes, such that when the plurality of X electrodes are functioning as the drive electrodes, the plurality of Y electrodes are functioning as the sense electrodes, and vice versa.

3. A system for increasing electric field projection from a touch sensor to obtain improved proximity sensing, said system comprised of:
a plurality of parallel X electrodes disposed in a first plane, and a plurality of parallel Y electrodes disposed in a second plane, wherein the Y electrodes are co-planar with but orthogonal to the X electrodes;
drive circuitry for simultaneously transmitting a drive signal on the plurality of X electrodes that are selected to function as the drive electrodes; and
sense circuitry for simultaneously receiving a signal from the plurality of Y electrodes that are functioning as the sense electrodes, wherein simultaneously driving the plurality of X or Y electrodes in a measurement cycle projects an electric field farther from the touch sensor than if the plurality of X or Y electrodes were toggled in smaller groups or as individual electrodes.

4. A method for reducing the effects of noise, decreasing power requirements and increasing a scan rate of a touch sensor, said method comprising:
providing a plurality of parallel X electrodes disposed in a first plane and providing a plurality of parallel Y electrodes disposed in a second plane, wherein the Y electrodes are co-planar with but orthogonal to the X electrodes;
transmitting a drive signal from the plurality of X electrodes and receiving sense signals on the plurality of Y electrodes in a first measurement cycle;
switching the functions of the plurality of X and Y electrodes;
transmitting a drive signal on the plurality of Y electrodes and receiving sense signals on the plurality of X electrodes in a second measurement cycle; and
reducing the effect of noise on the touch sensor by simultaneously receiving the sense signals during the first and second measurement cycles because all of the electrodes receiving the sense signals are affected simultaneously.

5. The method as defined in claim 4 wherein the method further comprises increasing a scan rate by collecting all the information needed to determine a position of a detectable object on the touch sensor during the first and second measurement cycles.

6. The method as defined in claim 4 wherein the method further comprises decreasing power requirements of the touch sensor by collecting all of the information needed to determine a position of a detectable object on the touch sensor during the first and second measurement cycles.

7. The method as defined in claim 4 wherein the method further comprises increasing electric field projection from the touch sensor to obtain improved proximity sensing by simultaneously driving the plurality of X or Y electrodes in the first and second measurement cycles to project the electric field farther from the touch sensor than if the plurality of X or Y electrodes were toggled in smaller groups or as individual electrodes.
